(19) United States
(12) Patent Application Publication
(10) Pub. No.: US 2009/0206574 A1
(43) Pub. Date: Aug. 20, 2009

(54) Lever Drive Wheelchair Transmission

(76) Inventor: Steve C. Green, West Fork, AR (US)

Correspondence Address: STEVE GREEN, 13387 GREEN ROAD, WEST FORK, AR, 72774, US

(21) Appl. No.: 12/031,367

(22) Filed: Feb. 14, 2008

(51) Int. Cl. B62M 1/16; F16H 27/02

(52) U.S. Cl. 280/250.1; 74/142

(57) ABSTRACT

A manual propulsion mechanism for wheelchairs utilizes a lever pivotally mounted to the hub of each rear wheel such that the wheelchair user can propel the chair with push/pull movements of the levers. Forward and reverse propulsion directions are accomplished by a system of one-way reversible clutches contained in the propulsion wheel hubs which also allow the levers to be operationally disconnected such that the chair can freewheel. Operator control of direction shifting is through twisting motions imparted to the grip handles of the propulsion levers. In a preferred embodiment, improved ergonomics for propulsion direction changes are made possible by an improved short excursion clutch shifting mechanism that reduces the angle of arc through which the operator must twist the grip handle to effect the direction change. This allows the operator to retain a comfortable, stable grip on the grip handle while simultaneously propelling and controlling direction of movement.

### CROSS-REFERENCE TO RELATED APPLICATIONS

Not applicable

### STATEMENT REGARDING FEDERALLY SPONSORED R&D

Not applicable

### REFERENCE TO SEQUENCE LISTING OR COMPUTER PROGRAM

Not applicable

### BACKGROUND OF THE INVENTION

Wheelchairs are typically intended to allow the user to move about without the use of their legs, and provide means of allowing arm movement to cause rotation of one or more wheels of the wheelchair. In the commonest and simplest form, round pushrims of slightly smaller diameter than the propelling wheels are fixed to the said propelling wheels, such that the user may conveniently grasp the pushrims to exert a rotational torque to the driving wheels through the pushrims. Although such means of propelling is simple, light in weight, and inexpensive, problems with pushrims include placing the users hand near the tires of the driving wheels which may be dirty, requiring considerable grip strength to grasp the pushrim, and repetitive motion injuries from the non-optimal bio-mechanics of grasping and pushing the pushrims. Efforts to provide solutions to these problems have often included lever drive mechanisms that allow the user to propel with reciprocating rowing type of motion. The levers can be located such that the pushing and pulling on the grip portion of the input lever provides improved biomechanics and keeps the users hand away from the driving wheels. Torque transmission from the input lever to the driving wheels typically involves some type of clutch action such that the wheelchair can be propelled in both forward and reverse directions. In this type of drive mechanism a means must be provided to allow the user to select either forward or reverse, and also to disengage the drive mechanism so that the wheelchair can be pushed by a caregiver.

### PRIOR ART

To this point in tile state of the art, lever drive mechanisms have all had deficiencies that limit general acceptance by potential users. These deficiencies include being too heavy, too bulky, having non-ergonomic forward/reverse shifting control inputs, and being obtrusive in appearance. Many levers drive inventions depend on a lever that is pivotally mounted forward of the rear drive wheels and that transmits torque to the drive wheels by way of chains, belts, or gear racks. Representative of this type of lever drive arrangement are U.S. Pat. Nos. 6,234,504, 5,007,655, and 4,652,026. This style of lever drive is exceptionally obtrusive in appearance, needlessly heavy, and has not been accepted by the user community.

Another style of lever drive incorporates the drive lever pivot spindle into the rear drive wheel hub. Although potentially less obtrusive than the forward mount lever arrangement discussed above, the bulky physical size of current hub mount lever drive mechanisms causes them to be placed on the outside of the driving wheel, and thus still objectionably obvious. Additionally, this placement causes the width of the wheelchair to increase, which is problematic for passing through typical doorways. U.S. Pat. No. 7,261,309 shows a wheelchair lever drive that is placed on the outside of each rear drive wheel. It uses roller clutches to effect forward/reverse directional control that are shifted in rotational sense by a handgrip 47 actuated pinion 17 that runs against a mating gear portion 2A on shift cage 2 of the clutch in the transmission. The relative pitch diameters necessary to the use of this pinion/gear arrangement result in less angular movement of shift cage 2 than is input by handgrip 47. Further, the conilnection betweeni handgrip 47 and pinion 17 is cable 49. This arranglement causes the torsional compliance of cable 49 to add angular lost motion to the shift angle input the user must apply to the handgrip. This results in an awkwardly large angle through which the user must rotate the handgrip in order to affect change of direction, forvard/reverse or reverse/forward shifts. In wheelchair operation change of direction shifts are very frequent, and this large angle of rotation forces the user to continually adjust their hand position on the grip of the propulsion lever. This condition significantly impairs the user experience, and predisposes users to forego using a lever drive wheelchair, other benefits notwithstanding. Additionally this invention uses multiple springs 5 of unusual and complex shape to cause rollers 3 to contact cam points 52 of cam disc 50 portion of the mechanism. Cam points 52 are of complex geometry and require high precision machining and grinding processes to fabricate. This results in an expensive clutch and control arrangement, not well suited to low production uses such as wheelchairs.

Various roller clutch mechanisms are known to the art, but fail to adequately address wheelchair lever drive needs. U.S. Pat. No. 6,210,300 presents a roller clutch invention that uses formed cam surfaces on tile inside diameter portion of the outer member of the clutch, with the rollers biased by individual springs. This type of clutch is complex and problematically expensive to manufacture in small quantities for wheelchair applications.

U.S. Pat. No. 6,953,412 discloses a reversible one-way clutch which incorporates cammed surfaces on either the outer periphery of an inner race, or the inner periphery of an outer race, in combination with cylindrical rollers, a cage portion containing said rollers and biasing springs for each roller, and a biasing plate 96 which functions to move the bias springs such that the clutch functions in either forward or reverse. It also, like other similar one-way reversible clutches, depends on a plurality of individual springs 114, generally either one or two per roller, to achieve torque transmission in a selectable direction of rotation. Due to the dependence on individual springs for roller biasing, the arrangement thus taught is limited to a bi-state operation, as the springs will push the rollers either one direction on the other, and are not intended or able to achieve an intermediate position. Therefore, either CW torque transmission with freewheeling CCW is achieved, or CCW torque transmission with freewheeling CW, thus lacking a neutral position allowing freewheeling both CW and CCW. Unique to this arrangement is the further incorporation of a biasing plate 96 to effect movement of the plurality of springs from one torque transmission state to the reverse. This arrangement as presented is of greater complexity and cost than is needed for wheelchair transmissions.

U.S. Pat. No. 5,765,669 teaches a reversible clutch type mechanism with features similar to U.S. Pat. No. 6,953,412 and U.S. Pat. No. 6,210,300 in that it incorporates rollers that can be positioned such that torque transmission in selected direction can be achieved. It also use a complex formed spring cage to position the rollers with respect to the cammed surfaces.

Consequently it may be seen that many inventions relating to lever drive wheelchair propulsion, and reversible clutching mechanisms utilizing rollers, springs, cages, and cammed surfaces have been invented. However, the specific needs of manual wheelchair propulsion by lever drive present challenges not adequately addressed by the state of the art.

### BRIEF SUMMARY OF THE INVENTION

The present invention improves on the state of the art by providing a lever propulsion means for manual wheelchairs that allows directional control shifting, forward/reverse and reverse/forward, with operator directional control input through the rotation of the propulsion lever handgrip of less angular excursion than previously utilized. This small angle direction shifting allows the operator to maintain a non-changing hand grip position such that propulsion movement of the levers may be comfortably simultaneous with direction shifting.

### OBJECTS OF THE INVENTION

It is therefore an object of this invention to provide a wheelchair lever drive propulsion mechanism that addresses the shortcomings in the state of the art mentioned above.

A further object of this invention is to provide a method to propel a wheelchair by means of a lever which can selectively rotate the wheelchair drive wheels either forward or reverse by the respective push or pull stroke of the lever, as well as a means to decouple the lever such that the wheelchair can freewheel, be propelled by conventional pushrims, or be moved by a caregiver.

A further object of this invention is to provide a lever drive propulsion mechanism that does not increase the width of the wheelchair.

A further object of this invention is to provide an ergonomically and operationally improved method of selecting the direction of lever drive wheelchair propulsion.

A further object of the invention is to provide a reversible one-way roller clutch system that can be shifted from one direction of rotation to the reverse of that by a control movement that is of smaller excursion than previous state of the art.

A further object of the invention is to provide a reversible one-way roller clutch system that provides a neutral position in which the clutch input and output elements can freewheel with respect to each other in either direction of rotation.

Another object of the invention is to provide a shifter over-travel compensation means that will protect the one-way clutch shifting mechanism from damage by shift motions of excessive excursion and force.

Another object of the invention is provide a means by which a user of the invention can change the relative sense of the transmission rotation by means of the same hand grip that is used to impart propelling motion to the lever.

Another object of the invention is to provide a reversible one-way clutch of less complexity and cost to manufacture than the current state of the art.

### BRIEF DESCRIPTION OF SEVERAL VIEWS OF THE INVENTION

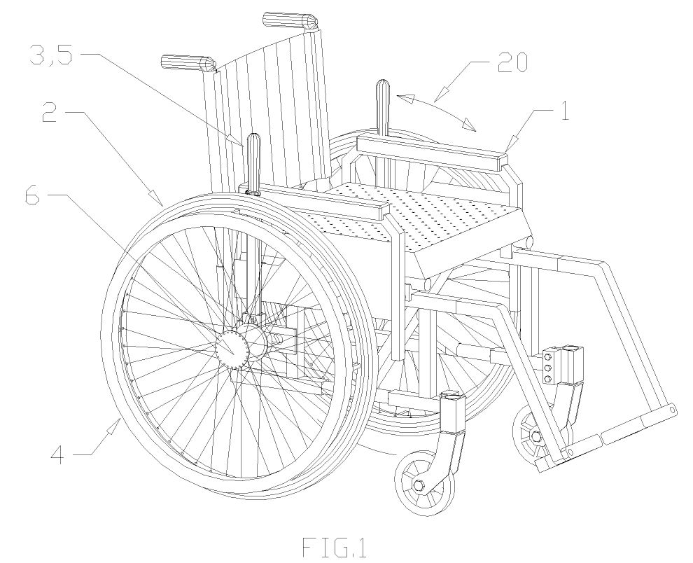

With reference to FIG. 1, a wheelchair I incorporates rear drive wheels 2 which are relatively larger than the front casters, each drive wheel 2 having attached a fixed pushrim 4. A propulsion lever 3 with grip portion 5 is shown pivotally mounted about the drive wheel 2 rotational axis. Each drive wheel 2 has a hub portion 6, which among other functions, houses rotating bearings that allow the wheel 2 to rotate about spindle 14.

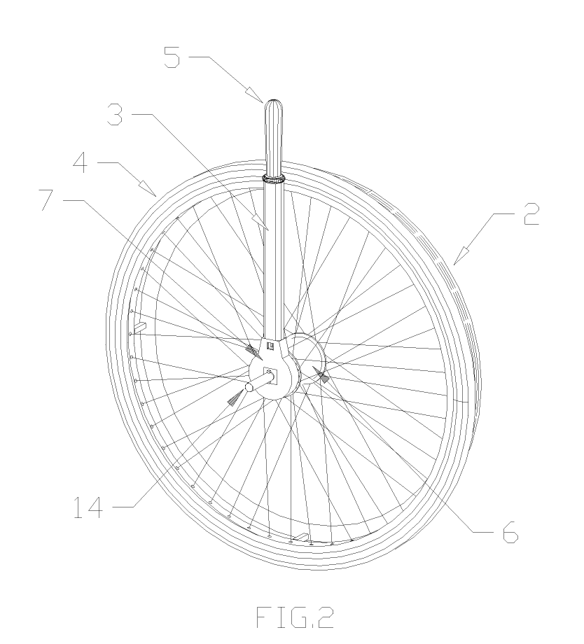

With reference to FIG. 2, a single rear drive wheel assembly 2 is shown from a perspective view point looking from the centerline of the wheelchair outward. This perspective is such that the inside mounting of the propulsion lever 3 causes it to be in the foreground of this view. Pushrim 4 is shown with rear drive wheel 2 partially obscured, and propulsion lever 3 mounted on wheel hub 6. A lever mount portion 7 of propulsion lever 3 is shown with wheel spindle 14 extending through it. Spindle 14 can be of such size and shape as to function with standardized wheel spindle sockets used throughout the wheelchair industry.

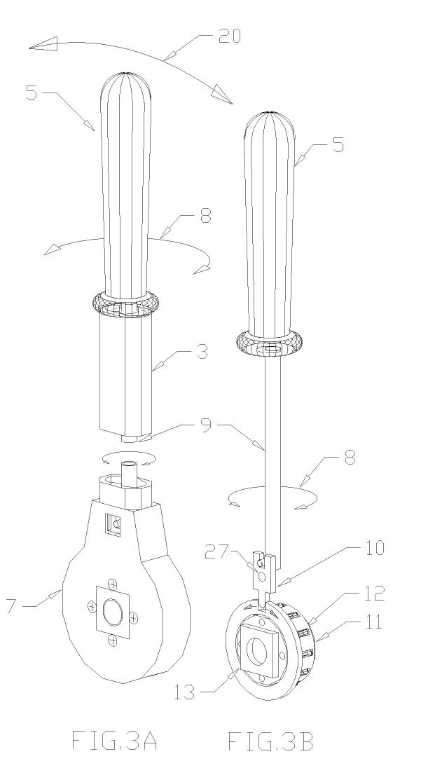

With reference to FIG. 3A, additional elements of the lever drive mechanism are depicted with propulsion lever 3 being foreshortened to allow greater detail to be shown. In this view, lever mount 7 is shown with lever 3 extending upwards with grip portion 5 at the top. The cutaway of lever 3 shows solid shift shaft 9 extended interiorly through lever 3 and into lever hub 7. FIG. 3B is a similar view to that in FIG. 3A, but with lever hub 7 and propulsion lever 3 removed to show more clearly the relative positions and interactions of the interior components. In FIG. 3B grip 5 is shown drivingly connected to solid shift shaft 9 such that a direction shift motion 8 causes a rotation of shaft 8. Also shown are cage 11 with associated rollers 12, input cain 13, and shift motion amplifying pawl 10, all of which would normally be interior to and hidden by, lever mount 7.

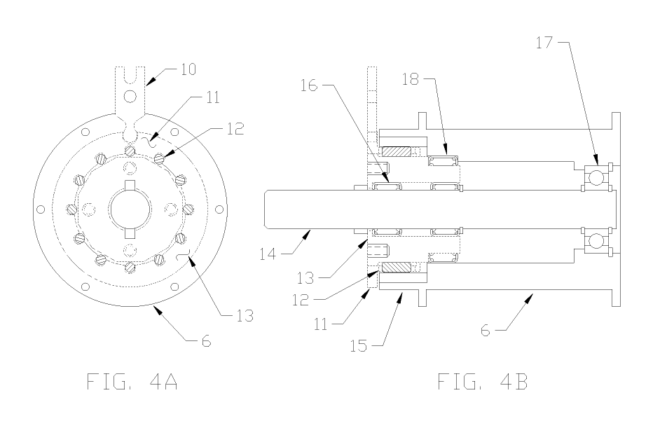

Shown in FIG. 4A is an end view of wheelchair hub 6 with lever mount 7 removed for clarity. Shift motion amplifying pawl 10 is shown in position to affect movement of cage 11 and the plurality of associated rollers 12 concentrically located around the periphery of input clutch cam 13. With reference to FIG. 4B, input clutch cam 13 can be seen rotationally supported by inside bearing 18 about spindle 14. Additionally, inside bearing 18, in combination with outside bearing 17, rotationally support wheel hub 6.

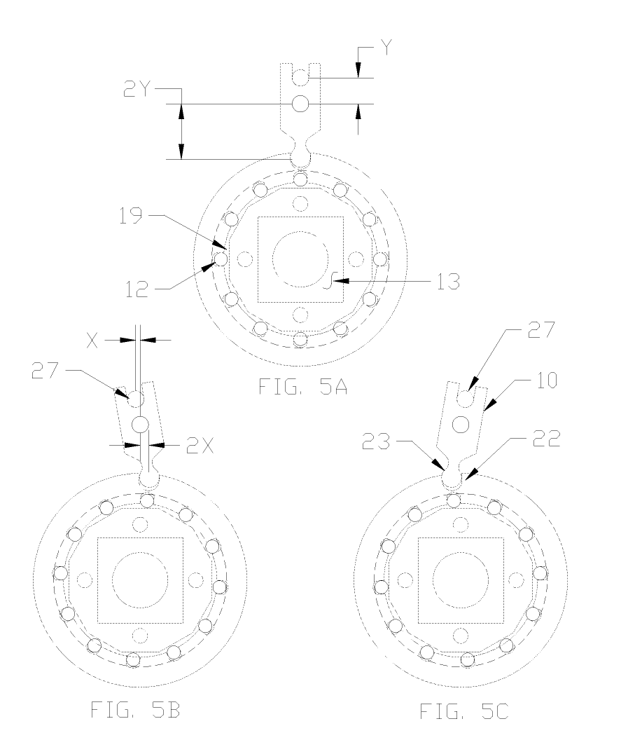

With reference to FIG. 5A, 5B, and 5C, input clutch cam 13, cage 11, and rollers 12, can be seen in three different operational positions. Shift motion amplifying pawl 10 incorporates a cage engaging portion 23 which may be configured as an elongated portion at one end of the pawl. Cage 11 incorporates a notch 22 on its outside diameter generally shaped to receive and be moved by cage engaging portion 23 of pawl 10. The inside diameter portion of cam race surface 21 is depicted as a dotted circle circumscribing rollers 12. FIG. 5A shows shift motion amplifying pawl 10 having positioned cage 11 such that associated rollers 12 are approximately at the midpoint of cam surface 19. In this position there is radial clearance between each roller 12 and its respective cam surface 19. In FIG. 5B, pawl 10 has rotated cage 11 clockwise (CW) sufficiently to move rollers 12 into contact effectively to the right side of cam surface 19. In FIG. 5C, pawl 10 has rotated cage 11 counter-clockwise (CCW) sufficiently to move rollers 12 into contact effectively with the left side of cam surface 19.

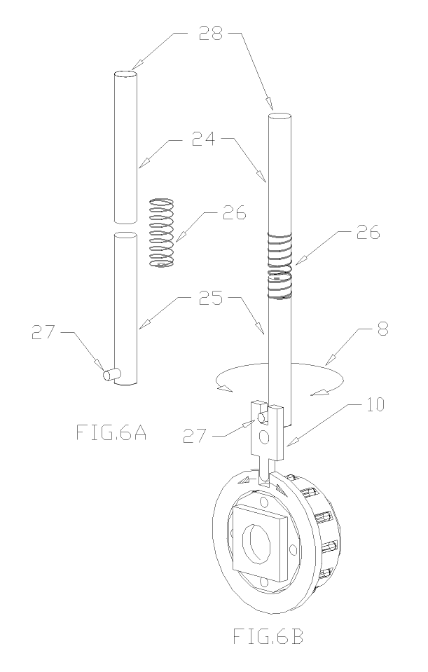

FIG. 6A and 6B illustrate an alternative embodiment of the invention incorporating an over-travel compensating shift shaft assembly 28 in place of solid shaft 9. Overtravel compensating shift shaft assembly 28 comprises an upper shift shaft 24, a compensator spring 26, and a lower shift shaft 25. Pawl engaging pin 27 is shown fixed near the lower end of shaft 25. FIG. 6A shows the components of shaft assembly 28 while FIG. 6B shows the components assembled and in operational position relative to shift motion amplifying pawl 10. Direction choosing shift motion 8 is depicted as a circle segment with arrows at each end. The shift motion imposed on cage 11 by pawl 10 is similarly shown by curved arrows.

### DETAILED DESCRIPTION OF THE INVENTION

With reference to FIGS. 1 through 6, a typical wheelchair 1 is shown with a preferred embodiment of the lever drive wheelchair transmission installed on the wheelchair frame. It can be seen that propulsion levers 3 and associated hand grips 5 are placed to the inside of rear drive wheels 2. This position is preferable to outside placement as it allows handgrips 5 to be closer together side-to-side in an ergonomically advantageous position, and, unique to this invention, does increase the overall width of the wheelchair. It also makes the overall lever drive mechanism aesthetically less obtrusive, a feature shown by independent survey to be important to users. Lever motion arrows 20 indicate the approximate arc of reciprocating motion that the user would impart to levers 20 when propelling chair 1.

When propelling wheelchair 1 a user would (,rasp grip 5 and push or pull., thus imparting a propelling motion shown by arrow 20, and could, as desired, impact a directional shift motion shown by circular arrow S. As shown by arrow 8, the shift motion can be relatively either CW or CCW, with a CCW rotation selecting forward motion, and CW rotation selecting reverse motion. It should be understood that the relationship between the direction the user twists tile grip for directional control and the direction in which the chair is propelled can he of opposite sense if desired. It may also be understood from this figure that for the user to comfortably shift directions, shift motion 8 must be of small angular excursion so as to not overstress the user's wrist. Uniquely to the transmission described in this invention, the shift motion amplifying pawl 10 causes relatively greater angular motion of cage 11 than is input by shift shaft 9, thus minimizing the angular control movement the user must impart to the handgrip. The ratio of this shift motion amplification can easily be chosen by modification of the dimensions “X” and “Y” of pawl 10. See FIG. 5.

Description of typical wheelchair propulsion using this invention will be in terms of left side rear wheel 2, as the figures illustrate that wheel in detail. It should be understood that a similar user input and control could be applied to the right side rear wheel also. To propel wheelchair 1, a user would grasp grip 5 and alternately push and pull in a reciprocating motion. When grip 5 is rotated slightly CCW as shown by shift motion 8, shift motion amplifying pawl 10 is pivoted by shift shaft 9 such that cage 11 is rotated slightly CCW, placing the associated rollers 12 in the engagement position as shown in FIG. 5C, and resulting in CW propelling motion being transmitted by cam 13 to cam race 21 and thereby to wheel 2. When the transmission is in the mode just described, forward push motion of lever 3 rotates drive wheel 2 in the forward sense, and pull motions cause the one-way clutch mechanism to overrun, allowing grip 5 to be pulled back into a ready position for another push motion. During this rearward pull stroke, wheelchair 1 is free to continue rolling forward.

Should the user desire to impart CCW (counter clockwise) motion to left rear wheel 1, they would rotate grip 5 slightly CW. This CW rotation of grip 5 is transmitted by shift shaft 9 to pawl 10 which causes cage 11 to rotate slightly CW, placing the associated rollers 12 in the engagement position as shown in FIG. B. This results in CCW propelling motion being transmitted to wheel 2. When the transmission is in the mode just described, rearward pull motion of lever 3 rotates drive wheel 2 in the rearward sense, and push motions cause the one-way clutch mechanism to overrun, allowing grip 5 to be push forward ready for another pull motion. During this forward push stroke, wheelchair 1 is free to continue rolling rearward.

Typical operation of manual wheelchairs require many forward and rearward direction changes, not just to actually go backward, but also for maneuvering, situations In tight quarters such as in a room with furniture, these directions changes are very frequent, and the transmission should make them possible with little effort to the user. One of several ways this invention improves on the current state of the art is by incorporating shift motion amplifying pawl 10. In the shifting and propelling sequence just described, shift motion input is imparted to grip 5 by the user. Since it is desirable for shift motion to happen simultaneously with propulsion, it can be understood that the mechanism should be of such design that the user's hand will not have to be removed from grip 5, or even repositioned. This makes a very small grip rotation 8 important. This is accomplished by the motion amplification provided by pawl 10. In FIG. 5, it can be seen that the ratio of dimensions “Y” and “2Y” is 2:1. Thus, as shown in FIG. 5B, a movement “X” by pawl engaging pin 27 of shift shaft 9 will result in a motion of “2X” being imparted to cage 11. Greater or lesser motion amplifications can easily be obtained as desired.

As described this invention makes possible directional shifting by uniquely small twist motions of grip 5 by the user. However, the actual propulsion pushing and pulling on grip 5 are large excursion, large force motions that could result in the shift motion being more robust than needed. In the current state of the art this can result in damage to the one-way clutch mechanism, particularly if the shifting means is not properly adjusted. This invention improves on the state of the art by incorporating an over-travel compensating shift shaft assembly 28 as shown in FIG. 6A and 6B. The assembly 28 comprises an upper shift shaft 24, a compensator spring 26, and a lower shift shaft 25. In operation, rotational shift motion 8 is imparted to upper shaft 24 in the same manner as described above. Upper shift shaft 24 is drivingly connected to spring (26, itself drivingly connected to lower shift shaft 25. Thus rotation of grip 5 is imparted to pawl engaging pin 27 as described above. However, in the event that grip 5 is rotated too far, perhaps due to misadjustment, instead of damaging pawl 10 or cage 11, the excess motion is accommodated by wind up of compensator spring 26. It should be understood that although a coil spring is shown, the intended function can be accomplished by any mechanical element that has spring qualities. This would include fabricating a shift shaft such that the shaft itself has resilient spring like qualities. Various spring rates can be chosen for spring 26 to suit the application.

What is claimed is:

1. A drive mechanism for manual propulsion of wheelchairs comprising:
A propulsion lever pivotally mounted to said wheelchair;
A wheel;
A drive mechanism interposed between said lever and said wheel incorporating means of causing pivoting motions of said lever to propel said wheelchair either in forward or reverse directions;
direction selecting means by which forvard or reverse propulsion can be chosen;
whereby a user may manually propel a wheelchair.

2. The drive mechanism of claim 1 wherein said means of causing pivoting motions of said lever to propel said wheelchair either in forvard or reverse directions comprises a one-way reversible clutch with means of reversing said clutch.

3. The drive mechanism of claim 2 wherein said one-way reversible clutch comprises a movable clutch race.

4. The drive mechanism of claim 2 wherein said means of reversing said clutch comprises a control motion amplifying pawl.

5. The drive mechanism of claim 1 wherein said direction selecting means comprises a rotatable elongated shaft located within said propulsion lever and communicating user control movement to said motion amplifying pawl

6. The drive mechanism of claim 5 wherein said user movement comprises rotation of a handgrip rotationally fixed to said propulsion lever.

7. A drive mechanism for manual propulsion of wheelchairs comprising:
A wheel;
A hollow propulsion lever pivotally mounted to said wheelchair;
A handgrip rotationally fixed to the upper end of said propulsion lever;
A rotatable elongated shaft placed internally to said hollow propulsion lever and drivingly connected to said handgrip;
A drive mechanism interposed between said propulsion lever and said wheel incorporating means of causing pivoting motions of said lever to propel said wheelchair either in forward or reverse directions;
Shifting means by which forward or reverse propulsion can be selected;
whereby a user may manually propel said wheelchair.

8. The drive mechanism of claim 7 wherein said means of causing pivoting motions of said propulsion lever to propel said wheelchair either in forward or reverse directions comprises a one-way reversible clutch with movable clutch race.

9. The drive mechanism of claim 7 wherein said rotational elongated shaft comprises an upper and lower shaft drivingly connected by a spring element and is capable by design of compensating for an excess of rotational movement.

10. The drive mechanism of claim 7 wherein said shifting means comprises a motion amplifying pawl.

11. A drive mechanism for manual propulsion of wheelchairs comprising:
A wheel;
A hollow propulsion lever pivotally mounted to said wheelchair;
A handgrip rotationally fixed to the upper end of said propulsion lever;
A drive mechanism interposed between said propulsion lever and said wheel incorporating a one-way reversible clutch capable of causing pivoting motions of said lever to propel said wheelchair in forward or reverse directions;
A rotatable elongated shaft capable of compensating for handgrip overtravel placed internally to said propulsion lever and drivingly connected to said handgrip
Shifting means comprising a motion amplifying pawl drivingly connected to said rotatable elongated shaft by which forward or reverse propulsion can selected;
whereby a user may manually propel said wheelchair.
